(19) United States
(12) Patent Application Publication
(10) Pub. No.: US 2013/0066734 A1
(43) Pub. Date: Mar. 14, 2013

(54) TRANSACTION RECORD GENERATION AND STORAGE

(71) Applicant: Moon J. Kim, Wappingers Falls, NY (US)

(72) Inventor: Moon J. Kim, Wappingers Falls, NY (US)

(21) Appl. No.: 13/231,080

(22) Filed: Sep. 13, 2011

(51) Int. Cl. G06Q 30/00

(52) U.S. Cl. 705/16; 705/304

(57) ABSTRACT

Embodiments of the present invention relate to an electronic transaction and more particularly to a method for generating and storing a record of a financial transaction in an electronic format. In one embodiment, a purchaser selects data relating to the purchaser to be included in the financial transaction record. The purchaser data that is selected is retrieved, along with any additional information to be included in the financial transaction record relating to the transaction. An electronic record of the financial transaction is generated based on the retrieved data. The electronic record of the financial transaction is stored in a database.

### TECHNICAL FIELD

In general, embodiments of the present invention relate to an electronic transaction and more particularly to a method for generating and storing a record of a financial transaction in an electronic format.

### BACKGROUND

Nearly every retail transaction involves the seller printing a receipt and providing the receipt to the purchaser (customer) which identifies each item bought by the purchaser. Generally, purchasers are provided with a paper sales receipt at the time of purchase. The purchaser may need to retain the receipt for a variety of reasons, such as requesting a refund or exchange for an item at a later time.

However, no standard format for receipts exists among sellers leading to receipt information that is sometimes difficult to understand and purchaser unfriendly. Another issue is that, at times, retail terminals fail to print a paper receipt due to terminal malfunction, paper shortage, or other reason. Also, even when printed successfully and given to the purchaser, the purchaser can lose the receipt or it can become damaged and unreadable.

### SUMMARY

In general, embodiments of the present invention provide an approach for generating and storing a financial transaction record between a seller and purchaser to a database in a financial management system that includes, but is not limited to, financial institutions or credit/debit card entities. The transaction record (TR) includes data selected by the purchaser which may include, but is not limited to, purchaser phone number, purchaser identification (ID) number, personal identification number (PIN), TR card data, or credit card data. Additional data stored in the TR record includes any necessary data needed to create a receipt, invoice, or other financial transaction.

A first aspect of the present invention provides a computer-implemented method for generating a financial transaction record between a seller and a purchaser, comprising: selecting by the purchaser a set of purchaser information to include in the financial transaction record; retrieving the set of purchaser information; retrieving a predefined set of financial transaction data to include in the financial record; generating an electronic record of the financial transaction based on the retrieved data; and storing the electronic record of the financial transaction in an electronic form in a database.

A second aspect of the present invention provides a system for generating a financial transaction record between a seller and a purchaser, comprising: a memory medium comprising instructions; a bus coupled to the memory medium; and a processor coupled to the bus that when executing the instructions causes the system to: accept as input from the purchaser a set of purchaser information to include in the financial transaction record; retrieve the set of purchaser information; retrieve a predefined set of financial transaction data to include in the financial record; generate an electronic record of the financial transaction based on the retrieved data; and store the electronic record of the financial transaction in an electronic form in a database.

A third aspect of the present invention provides a computer program product for generating a financial transaction record between a seller and a purchaser, the computer program product comprising a computer readable storage media, and program instructions stored on the computer readable storage media, to: accept as input from the purchaser a set of purchaser information to include in the financial transaction record; retrieve the set of purchaser information; retrieve a predefined set of financial transaction data to include in the financial record; generate an electronic record of the financial transaction based on the retrieved data; and store the electronic record of the financial transaction in an electronic form in a database.

A fourth aspect of the present invention provides a method for deploying a system for generating a financial transaction record between a seller and a purchaser, comprising: providing a computer infrastructure being operable to: accept as input from the purchaser a set of purchaser information to include in the financial transaction record; retrieve the set of purchaser information; retrieve a predefined set of financial transaction data to include in the financial record; generate an electronic record of the financial transaction based on the retrieved data; and store the electronic record of the financial transaction in an electronic form in a database.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2A depicts a graphical illustration according to an embodiment of the present invention in which the transaction medium and the user-selected transaction record account information are separate.

FIG. 2B depicts a graphical illustration according to an embodiment of the present invention in which the transaction medium contains the user-selected transaction record account information.

FIG. 3 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention provide an approach for generating and storing a financial transaction record between a seller and purchaser to a database in a financial management system that includes, but is not limited to, financial institutions or credit/debit card entities. Specifically, a purchaser (customer) selects data to relating to the purchaser to be included in the financial transaction record. The purchaser data that is selected is retrieved, along with any additional information to be included in the financial transaction record relating to the transaction. An electronic record of the financial transaction is generated based on the retrieved data. The electronic record of the financial transaction is stored in a database.

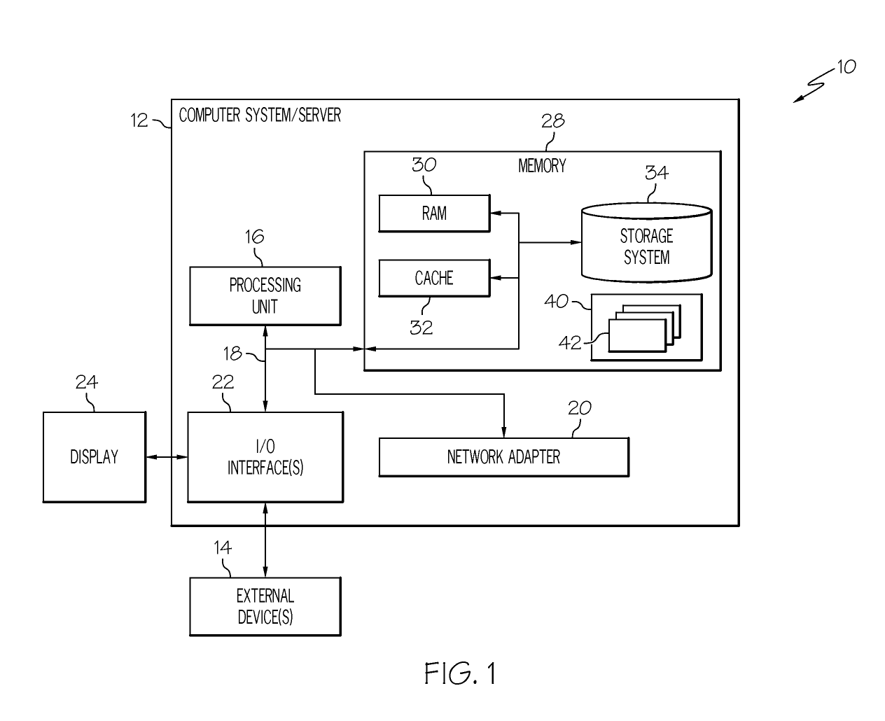

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Transmission routing program/utility 40, having a set (at least one) of program modules 42, may be stored in memory 28 by way of example, and not limitation, as well as an operating system, one or more application programs, other program modules, and program data. In general, transmission routing program 40 performs the function of the present invention as described herein. For example, transmission routing program 40 may compute a transmission routing total indicating a complexity of a proposed application migration, and provide various outputs (e.g., spreadsheets, charts, etc.) Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

When the purchaser (customer) has finished selecting all of the goods and/or services (hereinafter collectively referred to as “items”) that he wishes to purchase, he approaches the seller (or a representative of seller) to make payment for the items selected. The purchaser pays for the items in a variety of methods, such as by cash, credit or debit card, and the like. The purchaser elects the personal information to be stored in the transaction record (i.e., electronic receipt).

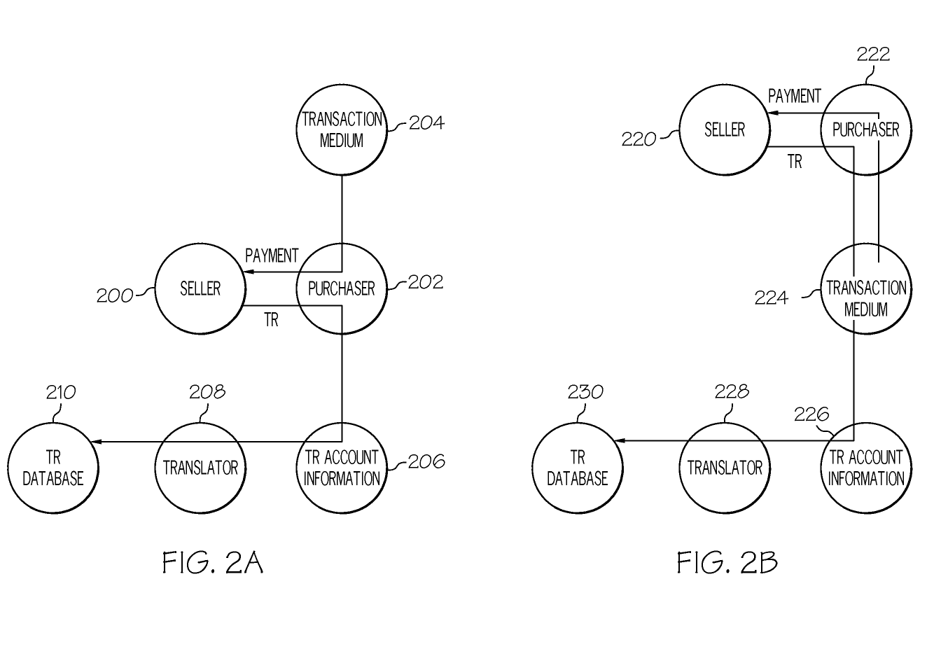

FIG. 2A depicts a graphical illustration according to an embodiment of the present invention in which the transaction medium and the user-selected data to include in the transaction record account information are separate (e.g., telephone number of purchaser). Seller 200 accepts payment from purchaser 202 using transaction medium 204. Transaction record (TR) account information 206 includes data not originating from transaction medium 204. TR account information 206 is translated by translator 208 into a common format. The translated TR data is stored in TR database 210.

FIG. 2B depicts a graphical illustration according to an embodiment of the present invention in which the transaction medium contains the user-selected transaction record account information. The personal information elected by the purchaser may come from the transaction medium (e.g., credit card number). Seller 220 accepts payment from purchaser 222 using transaction medium 224. Transaction record (TR) account information 226 includes data selected by the purchaser which comes from transaction medium 224. TR account information 226 is translated by translator 228 into a common format. The translated TR data is stored in TR database 230.

The purchaser-selected information may include, but is not limited to, purchaser phone number, purchaser identification (ID) number, personal identification number (PIN), TR card data, or credit card data.

Additional data stored in the TR record includes any necessary data needed to sufficiently create the respective receipt, invoice, or other financial transaction record. The purchaser data that is selected is retrieved, along with any additional information to be included in the financial transaction record relating to the transaction. An electronic record of the financial transaction is generated based on the retrieved data. The electronic record of the financial transaction is translated to a predefined format and stored in a database.

The seller can employ a number of technology-assisted devices that are capable of generating the electronic data regarding the sales transaction. The device can be a standalone unit or a software program that can be incorporated in the computer registers. The device may be capable of generating paper receipts or electronic receipts. The device may be programmed to generate only electronic receipts when the device is incapable of generating a paper receipt.

The device can also be programmed to transmit notification to the purchaser that the transaction record has been stored in a database. If the purchaser chooses, the transaction can be forwarded an electronic mail (e-mail) address or mobile device.

Also, the transaction record can be forwarded to a service provider which can be made accessible to the purchaser via a computer. The transaction record can be downloadable to the purchaser's computer upon demand or periodically, depending on the types of service provided by the provider and user preference. The purchaser can print the receipt onto paper if the customer needs to return an item to the seller.

The seller's device (e.g., cash register) allows the seller to record the electronic receipt information at the point of sale. The purchaser is prevented from returning an item purchased at a different location. Mistakes between the customer and seller are likely reduced when the receipts are stored in an electronic form. A disinterested third party, such as the service provider, can act as an intermediary by storing copies of the transaction records that cannot be altered by either the purchaser or the seller.

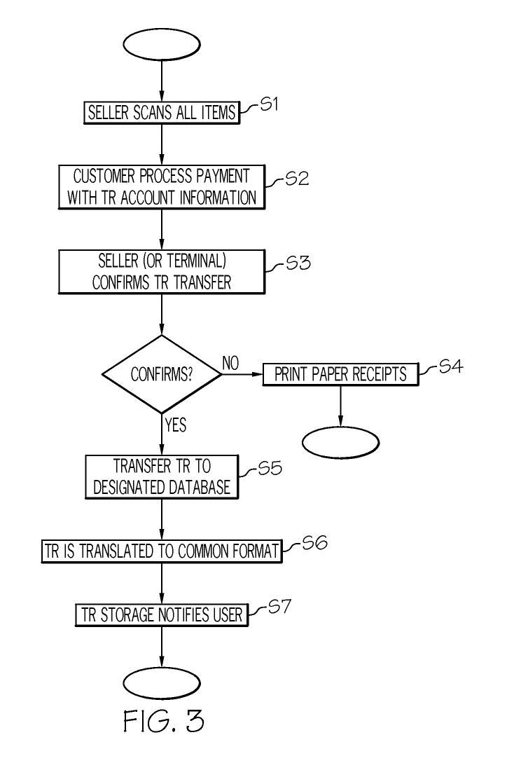

FIG. 3 depicts a method flow diagram according to an embodiment of the present invention. In S1, the seller scans all the items selected for purchase by the customer (purchaser). In S2, the customer processes payment using customer-selected transaction record (TR) account information. In S3, the seller (or the seller's terminal/register) confirms the transaction record transfer. In S4, if the transfer is not confirmed, a paper receipt is produced for the purchaser. In S5, if the transfer is confirmed, the TR is transferred to a designated database. In S6, the TR is written to the database in a common format. In S7, the customer is notified regarding TR storage.

While shown and described herein as a financial transaction record generation solution, it is understood that the invention further provides various alternative embodiments. For example, in one embodiment, the invention provides a computer-readable/useable medium that includes computer program code to enable a computer infrastructure to provide financial transaction record generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a computer-implemented method for generating a financial transaction record. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for generating a financial transaction record between a seller and a purchaser, comprising:
selecting by the purchaser a set of purchaser information to include in the financial transaction record;
retrieving the set of purchaser information;
retrieving a predefined set of financial transaction data to include in the financial record;
generating an electronic record of the financial transaction based on the retrieved data; and
storing the electronic record of the financial transaction in an electronic form in a database.

2. The computer-implemented method of claim 1, further comprising the step of providing the purchaser with unique identification data.

3. The computer-implemented method of claim 1, further comprising the step of transmitting the electronic record to an electronic device controlled by the purchaser at the point of purchase.

4. The computer-implemented method of claim 1, further comprising the step of transmitting the electronic record to a remote service provider for storage and subsequent retrieval by the purchaser.

5. The computer-implemented method of claim 1, further comprising the step of translating the electronic record to a predefined format prior to storing the electronic record.

6. A system for generating a financial transaction record between a seller and a purchaser, comprising:
a memory medium comprising instructions;
a bus coupled to the memory medium; and
a processor coupled to the bus that when executing the instructions causes the system to:
accept as input from the purchaser a set of purchaser information to include in the financial transaction record;
retrieve the set of purchaser information;
retrieve a predefined set of financial transaction data to include in the financial record;
generate an electronic record of the financial transaction based on the retrieved data; and
store the electronic record of the financial transaction in an electronic form in a database.

7. The system of claim 6, the memory medium further comprising instructions for providing the purchaser with unique identification data.

8. The system of claim 6, the memory medium further comprising instructions for transmitting the electronic record to an electronic device controlled by the purchaser at the point of purchase.

9. The system of claim 6, the memory medium further comprising instructions for transmitting the electronic record to a remote service provider for storage and subsequent retrieval by the purchaser.

10. The system of claim 6, the memory medium further comprising instructions for translating the electronic record to a predefined format prior to storing the electronic record.

11. A computer program product for generating a financial transaction record between a seller and a purchaser, the computer program product comprising a computer readable storage media, and program instructions stored on the computer readable storage media, to:
accept as input from the purchaser a set of purchaser information to include in the financial transaction record;
retrieve the set of purchaser information;
retrieve a predefined set of financial transaction data to include in the financial record;
generate an electronic record of the financial transaction based on the retrieved data; and
store the electronic record of the financial transaction in an electronic form in a database.

12. The computer program product of claim 11, the computer readable storage media further comprising instructions to provide the purchaser with unique identification data.

13. The computer program product of claim 11, the computer readable storage media further comprising instructions to transmit the electronic record to an electronic device controlled by the purchaser at the point of purchase.

14. The computer program product of claim 11, the computer readable storage media further comprising instructions to transmit the electronic record to a remote service provider for storage and subsequent retrieval by the purchaser.

15. The computer program product of claim 11, the computer readable storage media further comprising instructions to translate the electronic record to a predefined format prior to storing the electronic record.

16. A method for deploying a system for generating a financial transaction record between a seller and a purchaser, comprising:
providing a computer infrastructure being operable to:
accept as input from the purchaser a set of purchaser information to include in the financial transaction record;
retrieve the set of purchaser information;
retrieve a predefined set of financial transaction data to include in the financial record;
generate an electronic record of the financial transaction based on the retrieved data; and
store the electronic record of the financial transaction in an electronic form in a database.

17. The method of claim 16, the computer infrastructure being further operable to provide the purchaser with unique identification data.

18. The method of claim 16, the computer infrastructure being further operable to transmit the electronic record to an electronic device controlled by the purchaser at the point of purchase.

19. The method of claim 16, the computer infrastructure being further operable to transmit the electronic record to a remote service provider for storage and subsequent retrieval by the purchaser.

20. The method of claim 16, the computer infrastructure being further operable to translate the electronic record to a predefined format prior to storing the electronic record.
